(19) United States
(12) Patent Application Publication
(10) Pub. No.: US 2007/0041510 A1
(43) Pub. Date: Feb. 22, 2007

(54) Telephone apparatus, telephone switchboard, and telephone line connection method

(75) Inventor: Hiroshi Sawakuri, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC INFRONTIA CORPORATION

(21) Appl. No.: 11/436,658

(22) Filed: May 19, 2006

(30) Foreign Application Priority Data
May 20, 2005 (JP) 2005-148011

(51) Int. Cl. H04M 1/24

(52) U.S. Cl. 379/27.01; 379/375.01

(57) ABSTRACT

The telephone apparatus prevents a ringer sound from being produced from a handset after the handset is off-hook by an incoming call while using a conventional subscriber line of a central telephone exchange. A telephone apparatus includes a ringer signal detection unit that detects a ringer signal, and a disconnection unit that disconnects a loudspeaker from a line while the ringer signal detection unit detects the ringer signal.

### BACKGROUND OF THE INVENTION

1. Field of the Invention

The present invention relates to a telephone apparatus, a telephone switchboard, and a telephone line connection method for holding a conversation or the like through a public telephone network. More specifically, the present invention relates to a telephone apparatus, a telephone switchboard, and a telephone line connection method having ringer-related characteristics.

2. Description of the Related Art

FIG. 1 is a circuit diagram of a telephone apparatus according to a conventional example. FIG. 2 is a circuit diagram of ringer-related constituent elements of a subscriber circuit of a central telephone exchange and those of the telephone apparatus.

Referring to FIGS. 1 and 2, terminals L1 and L2 of the telephone apparatus are connected to the subscriber circuit. If the telephone apparatus receives a telephone call, switches SWA and SWB of the subscriber circuit are turned on. Between the terminals L1 and L2, a direct-current (DC) voltage generated by a DC power supply V_{DC} and an alternating-current (AC) voltage generated by an AC power supply V_{AC} are applied. If so, a capacitor C1 blocks the DC voltage while and only the AC voltage is applied to a ringer B. The ringer B thereby outputs a ringer sound. A frequency of this AC voltage is 16 hertz. In addition, after this AC voltage continues to be applied for one second, application thereof is halted for two seconds. This operation is performed repeatedly.

If a handset is off-hook, hook switches HS1 and HS2 of the telephone apparatus are turned on. Accordingly, within the telephone apparatus, a short-circuit path via a switch D1 (which is turned on), a transformer L, a loudspeaker T, and the switch HS2 is formed between the terminals L1 and L2. If so, a DC voltage is generated on both ends of a resistor R_{A} of the subscriber circuit. If detecting that the DC voltage is generated on the both ends of the resistor R_{A}, a control unit (not shown) of the subscriber circuit turns off the switches SWA and SWB. The ringer B thereby finishes outputting the ringer sound.

Thereafter, the telephone apparatus turns into a conversation state, and starts transmitting and receiving a voice and the like to and from a telephone apparatus of a conversation partner through a feed switching, testing, feeding, monitoring, two-wire/four-wire conversion, and coding units S of the subscriber circuit.

However, as shown in FIG. 3, during a period since the hook switches HS1 and HS2 are turned on until the switches SWA and SWB are turned off and stopped the ringer sound, a delay time is generated resulting from an operating rate of the control unit of the subscriber circuit, a transmission time for transmitting a signal over the telephone line, and the like. If a time since a user leaves the handset off-hook until the user holds the handset to the user's ear is longer than this delay time, no problem occurs. If not, the AC voltage generated by the AC power supply V_{AC} drives the loudspeaker T to output the ringer sound. As a result, the user hears the ringer sound from the handset held to the user's ear. In this case, the user hears the ringer sound offensive noise.

The Japanese Patent Application Laid-Open No. 57-206151 discloses the invention to solve the problems in an apparatus in a central telephone exchange.

### SUMMARY OF THE INVENTION

It is an object of the present invention to provide a telephone apparatus, a telephone switchboard, and a telephone line connection method capable of preventing a ringer sound from being produced from a handset after the handset is off-hook by an incoming call while using a conventional subscriber line of a central telephone exchange.

According to a first aspect of the present invention, there is provided a telephone apparatus comprising: ringer signal detection means for detecting a ringer signal; and disconnection means for disconnecting a loudspeaker from a line while the ringer signal detection means detects the ringer signal.

In the telephone apparatus according to the first aspect, the ringer signal detection means may output a direct-current signal while the ringer signal has an alternating-current amplitude.

According to a second aspect of the present invention, there is provided a telephone line connection method comprising: a ringer signal detection step of detecting a ringer signal; and a disconnection step of disconnecting a loudspeaker from a line while the ringer signal is detected at the ringer signal detection step.

In the telephone line connection method according to the second aspect, at the ringer signal detection step, a direct-current signal may be output while the ringer signal has an alternating-current amplitude.

According to a third aspect of the present invention, there is provided a telephone switchboard comprising: ringer signal detection means for detecting a ringer signal; and disconnection means for disconnecting a conversation unit of a station line interface unit from a conversation unit of an extension interface unit while the ringer signal detection means detects the ringer signal.

In the telephone switchboard according to the third aspect, the ringer signal detection means may output a direct-current signal while the ringer signal has an alternating-current amplitude.

According to a fourth aspect of the present invention, there is provided a telephone line connection method, comprising: a ringer signal detection step of detecting a ringer signal; and a disconnection step of disconnecting a conversation unit of a station line interface unit from a conversation unit of an extension interface unit while the ringer signal is detected at the ringer signal detection step.

In the telephone line connection method according to the fourth aspect, at the ringer signal detection step, a direct-current signal may be output while the ringer signal has an alternating-current amplitude.

### BRIEF DESCRIPTION OF THE DRAWINGS

FIG. 1 is a circuit diagram of a configuration of a telephone apparatus according to a conventional example;

FIG. 2 is a circuit diagram of a configuration of a subscriber circuit of a central telephone exchange;

FIG. 3 is a timing chart of operations while a handset is off-hook according to the conventional example;

FIG. 4 is a circuit diagram of a configuration of a telephone apparatus according to a first embodiment of the present invention;

FIG. 5 is a timing chart of operations performed in the telephone apparatus according to the first embodiment;

FIG. 6 is a circuit diagram of a configuration example of a ringer signal detection unit shown in FIG. 4;

FIG. 7 is a timing chart of operations performed by the ringer signal detection unit shown in FIG. 6;

FIG. 8 is a flowchart of operations performed by a CPU if a waveform shaping unit shown in FIG. 6 includes the CPU and a recording medium;

FIG. 9 is a block diagram of a configuration of a telephone switchboard according to a second embodiment of the present invention;

FIG. 10 is a block diagram of a configuration of a telephone switchboard according to a third embodiment of the present invention; and

FIG. 11 is a block diagram of a configuration of a telephone apparatus according to a fourth embodiment of the present invention.

### DESCRIPTION OF THE PREFERRED EMBODIMENTS

Preferred embodiments of the present invention will be described hereinafter with reference to the drawings.

### First Embodiment

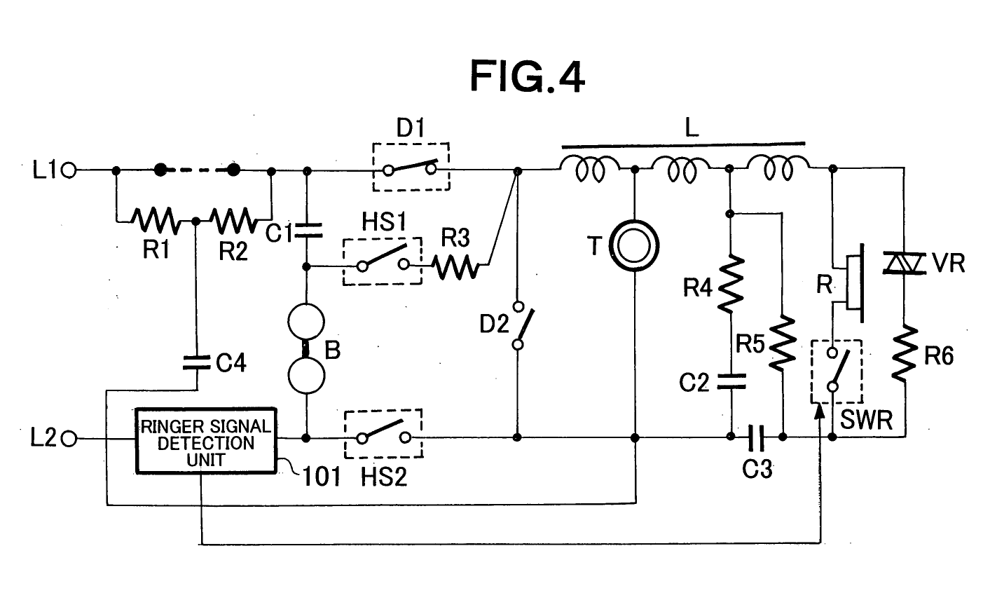

FIG. 4 is a circuit diagram of a configuration of a telephone apparatus according to the first embodiment of the present invention.

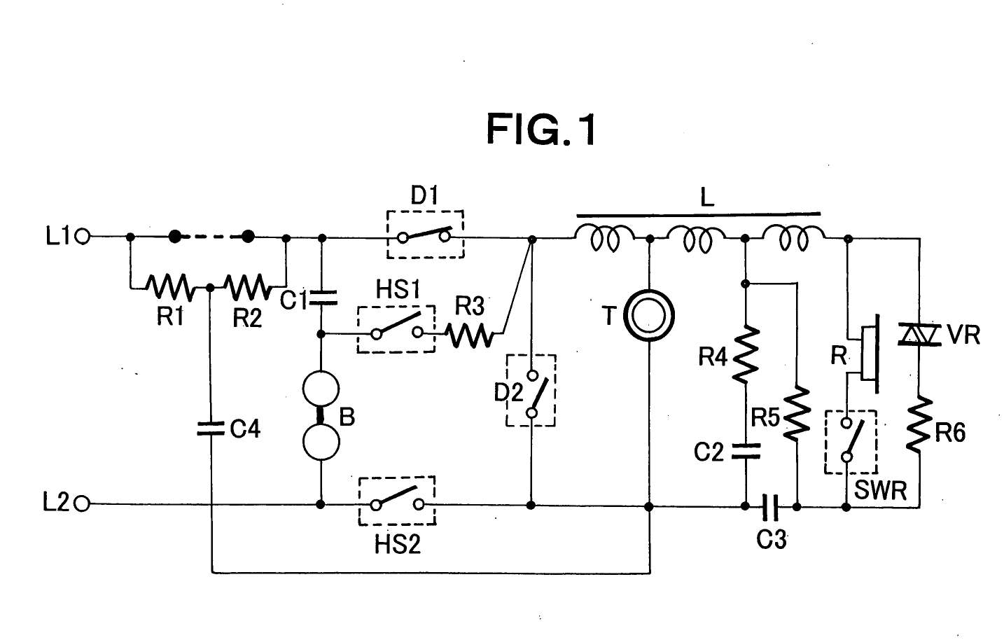

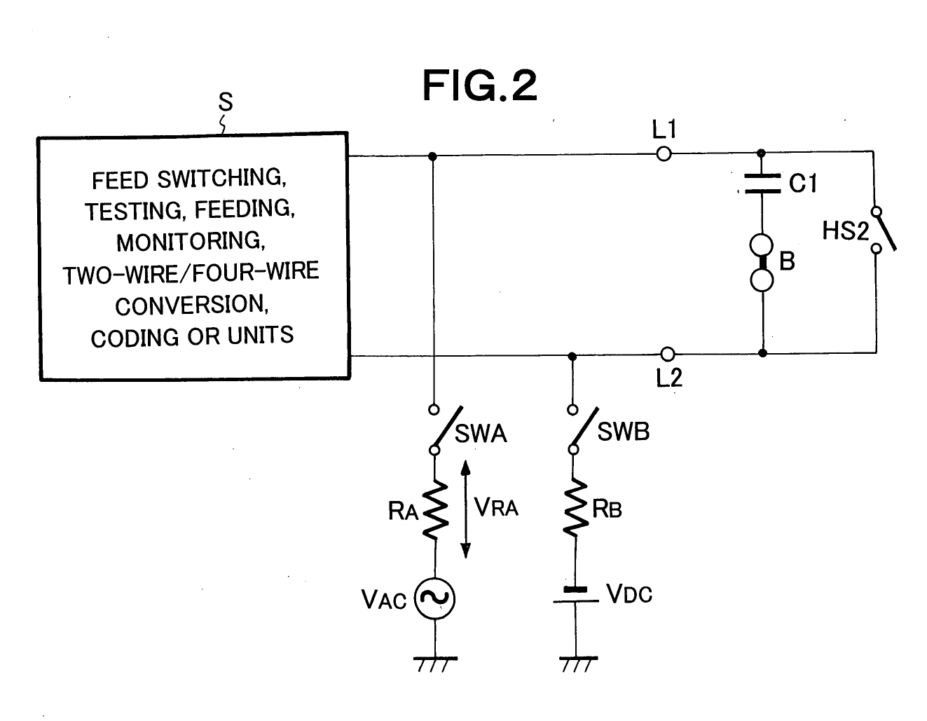

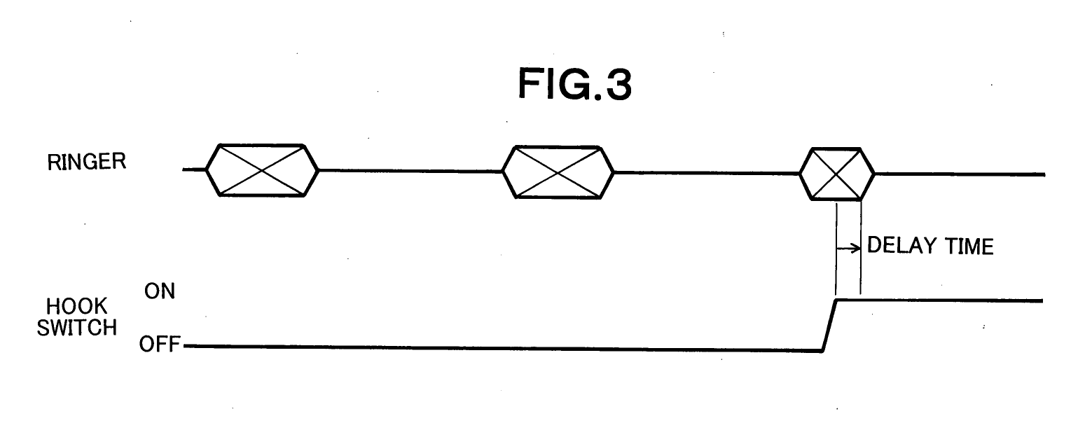

The telephone apparatus according to this embodiment differs from the telephone apparatus according to the conventional example shown in FIG. 1 in that the apparatus additionally includes a ringer signal detection unit 101 and a loudspeaker switch SWR.

The same constituent elements of the telephone apparatus according to this embodiment as those shown in FIG. 1 are well known as disclosed in, for example, Japanese Patent Application Laid-Open No. 61-148944. Therefore, they will not be repeatedly described herein.

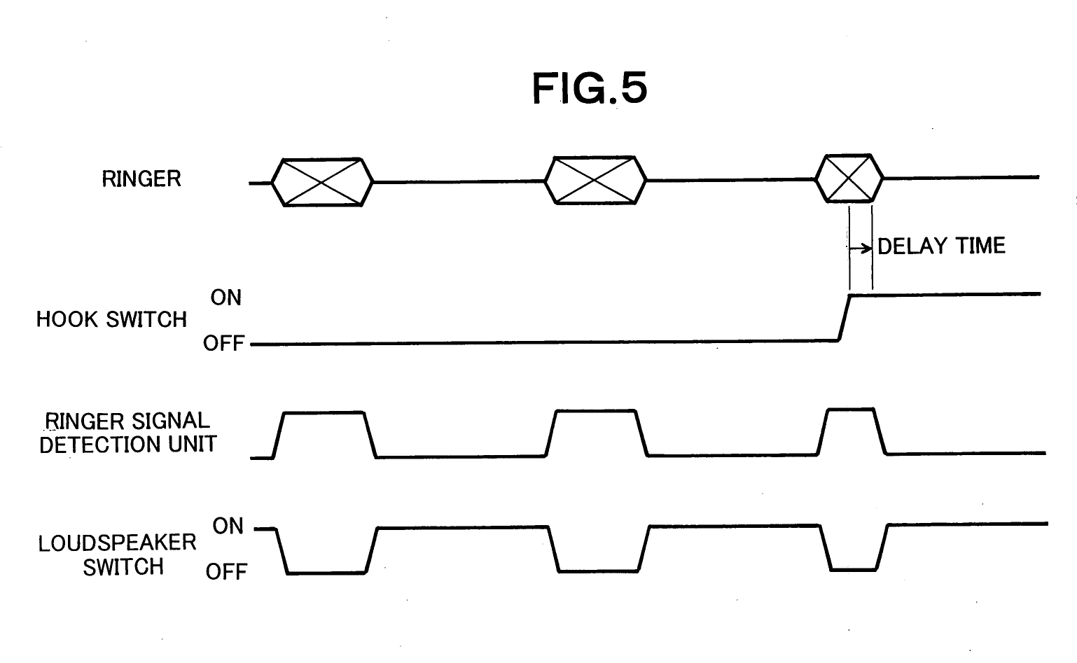

As shown in FIG. 5, the ringer signal detection unit 101 turns an active level while a ringer signal has an AC amplitude, and the unit 101 turns an inactive level and outputs a ringer signal detection signal in the other period. As shown in FIG. 5, the loudspeaker switch SWR is turned off while the ringer detection signal is at an active level, and the switch SWR is turned off in the other period. By so setting, even if a delay time is present since a hook switch is turned on until the ringer signal is turned off, the ringer signal is not applied to a loudspeaker. In the period in which the ringer signal is absent, a connection is established as usual. Therefore, even if a signal such as a signal that represents identification information (a caller number, a caller name, and the like) on a caller is applied to the telephone apparatus while the ringer signal is absent, the telephone apparatus can normally process the signal. Accordingly, it is possible to avoid a situation, for example, in which the caller number and the caller name are not displayed on a number display of the telephone apparatus.

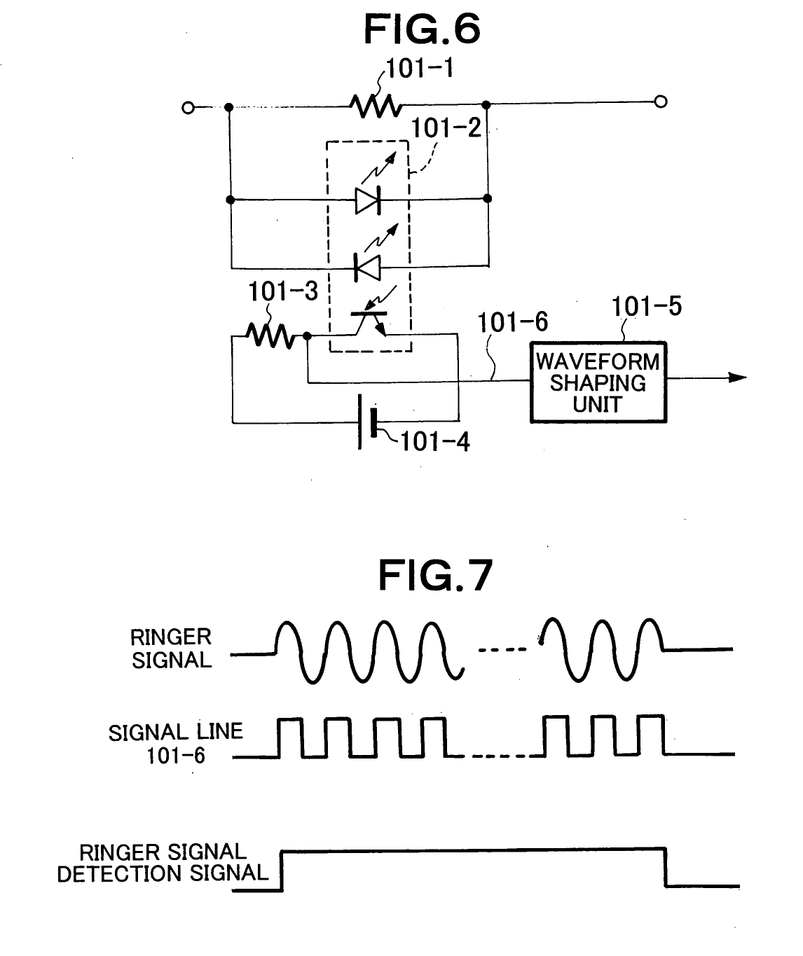

FIG. 6 is a circuit diagram of a configuration example of the ringer signal detection unit 101 shown in FIG. 4.

Referring to FIG. 6, the ringer signal detection unit 101 includes a resistor 101-1, a photocoupler 101-2, a resistor 101-3, a DC power supply 101-4, and a waveform shaping unit 101-5.

One of photodiodes in the photocoupler 101-2 emits a light according to a polarity of a signal applied from a subscriber circuit in response to the ringer signal. Accordingly, a photodiode of the photocoupler 101-2 is turned on, and a signal shown in FIG. 7 is generated on a signal line 101-6.

The waveform shaping unit 101-5 is constituted by, for example, a one-sided detector employed for an AM detector or the like or a non-triggerable monomulti vibrator. The waveform shaping unit 101-5 outputs a signal shown in FIG. 7.

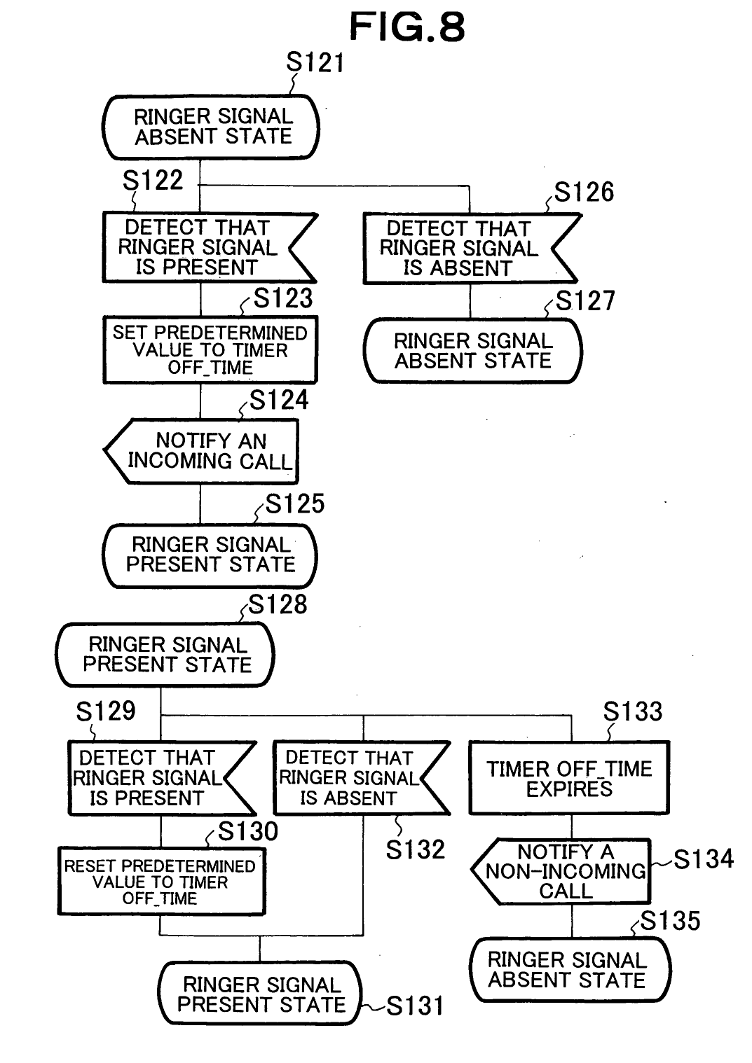

The waveform shaping unit 101-5 may include a central processing unit (CPU) and a recording medium, e.g., a read-only memory (ROM), which records a program executed by the CPU. If so, the CPU operates as shown in FIG. 8. Referring to FIG. 8, a “ringer signal absent state” or a “ringer signal present state” is an internal state of the CPU. The CPU regularly starts the program. At the time of starting the program, the CPU checks the internal state thereof, and starts operating at a step S121 or S128. If the internal state is the “ringer signal absent state” at the time of starting the program, the CPU starts operating at the step S121. If confirming that a present level of the signal line 101-6 is HIGH, the CPU determines that it detects that “ringer signal is present” (at a step S122), and sets a predetermined value to timer OFF_TIME (at a step S123). In addition, the CPU notifies an incoming call by setting the ringer detection signal to HIGH level (at a step S124), and changes the internal state to the “ringer signal present state” (at a step S125). If the CPU starts operating at the step S121 and confirms that the present level of the signal line 101-6 is LOW, the CPU determines that it detects that “ringer signal is absent” (at a step S126), and makes the internal state thereof remain the “ringer signal absent state” (at a step S127). If the internal state is the “ringer signal present state” at the time of starting the program, the CPU starts operating at the step S128. If confirming that the present level of the signal line 101-6 is HIGH, the CPU determines that it detects that “ringer signal is present” (at a step S129), resets the predetermined value to the timer OFF_TIME (at a step S130), and makes the internal state remain the “ringer signal present state” (at a step S131). If the CPU starts operating at the step S128 and confirms that the present level of the signal line 101-6 is LOW, the CPU determines that it detects that “ringer signal is absent” (at a step S132), and makes the internal state remain the “ringer signal present state” (at the step S131). If the CPU starts operating at the step S128 and the timer OFF_TIME expires irrespective of the present level of the signal line 101-6 (at a step S133), the CPU notifies a non-incoming call by setting the ringer signal detection signal to LOW level (at a step S134), and changes the internal state to the “ringer signal absent state” (at a step S135).

### Second Embodiment

The first embodiment is an improvement of the telephone apparatus installed in a house or the like. The second embodiment is an improvement of a telephone switchboard installed in a company office or the like similarly to the first embodiment.

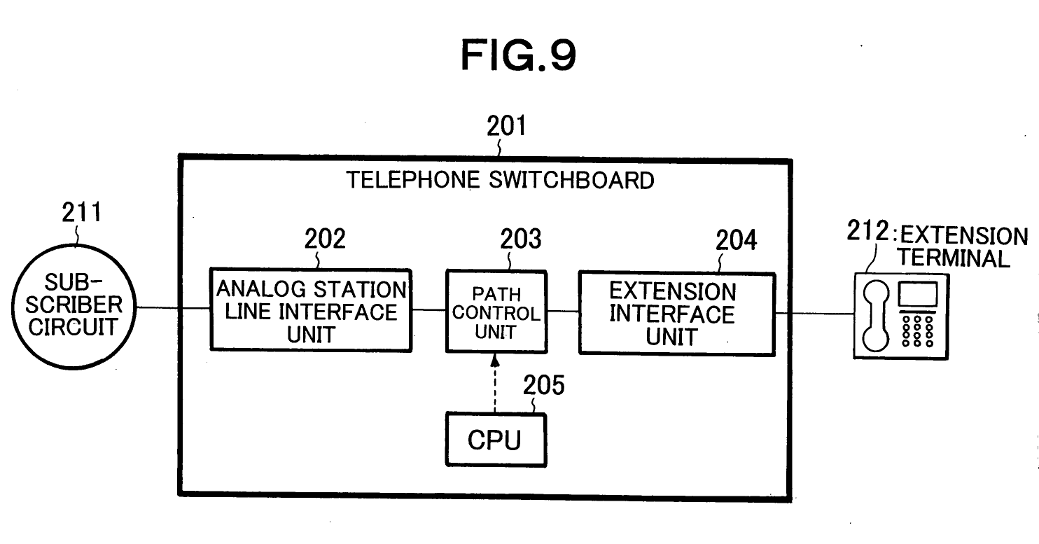

Referring to FIG. 9, a telephone switchboard 201 according to the second embodiment includes an analog station line interface unit 202, a path control unit 203, an extension interface unit 204, and a CPU 205.

The analog station line interface unit 202 is connected to a subscriber circuit 211 of a central telephone exchange. The extension interface unit 204 is connected to an extension terminal 212. The path control unit 203 connects the analog station line interface unit 202 to the extension interface unit 204. The CPU 205 controls the path control unit 203.

The CPU 205 controls the path control unit 203 while the ringer signal detection unit 101 detects the ringer signal, thereby disconnecting a conversation unit of the analog station line interface unit 202 from that of the extension interface unit 204.

By doing so, it is possible to prevent a ringer sound from being output from a loudspeaker of the extension terminal 212.

### Third Embodiment

The third embodiment is a modification of the second embodiment.

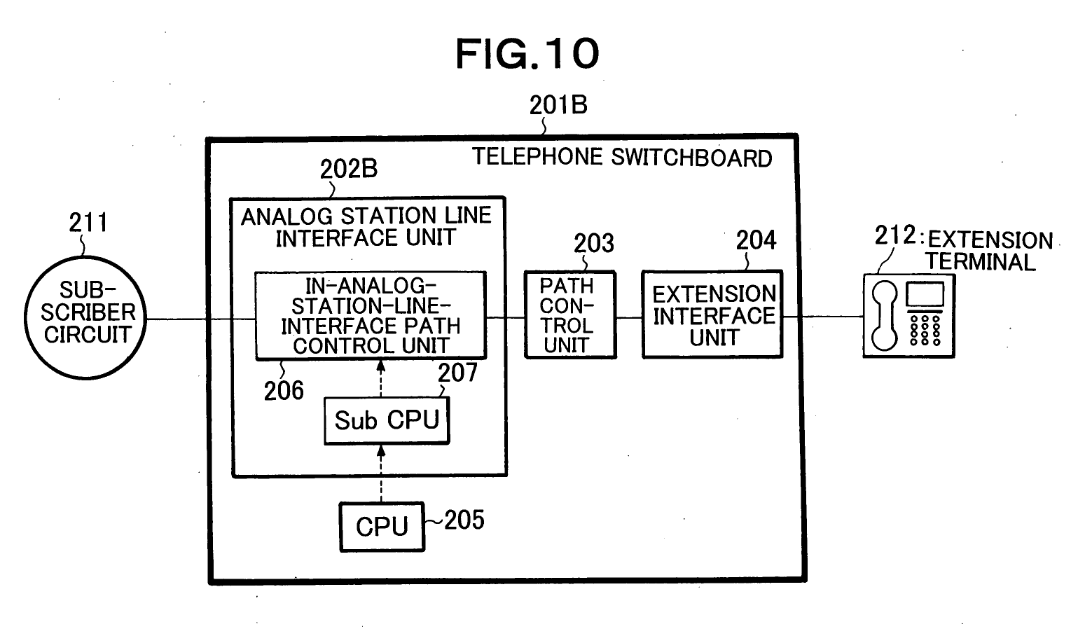

Referring to FIG. 10, a telephone switchboard 201B according to the third embodiment includes an analog station line interface unit 202B, the path control unit 203, the extension interface unit 204, and the CPU 205. The analog station line interface unit 202B includes an in-analog-station-line-interface path control unit 206 and a Sub CPU 207.

The analog station interface unit 202B is connected to the subscriber circuit 211 of the central telephone exchange. The extension interface unit 204 is connected to the extension terminal 212. The path control unit 203 connects the analog station interface unit 202B to the extension interface unit 204. The CPU 205 includes the Sub CPU 207. The Sub CPU 207 controls the in-analog-station-line-interface path control unit 206.

The CPU 205 controls the in-analog-station-line-interface path control unit 206 through the Sub CPU 207 while the ringer signal detection unit 101 detects the ringer signal, thereby disconnecting a conversation unit of the analog station line interface unit 202B from that of the extension interface unit 204.

By doing so, it is possible to prevent the ringer sound from being output from the loudspeaker of the extension terminal 212.

### Fourth Embodiment

The fourth embodiment is a modification of the first embodiment.

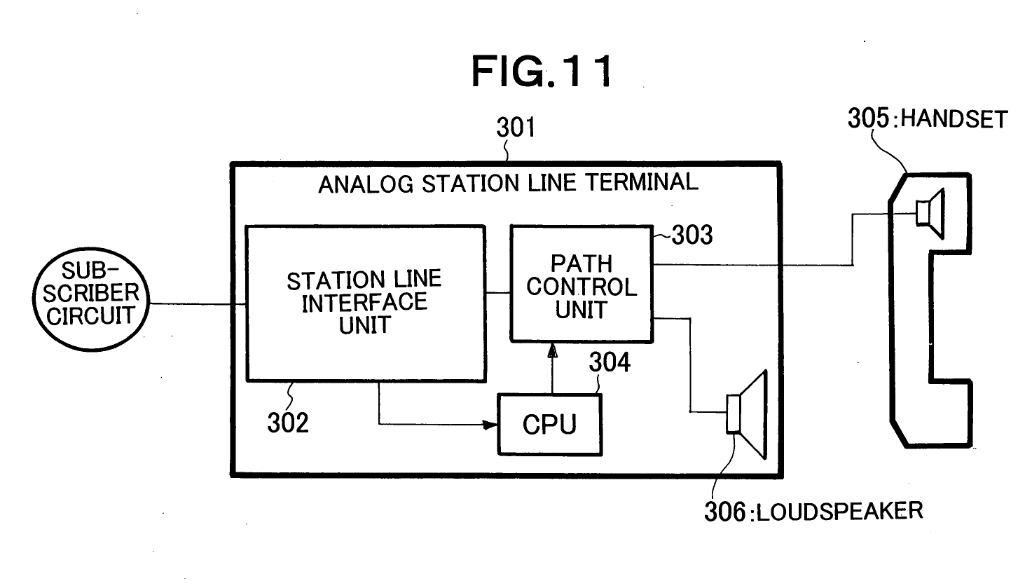

Referring to FIG. 11, an analog station line terminal 301 according to the fourth embodiment includes a station line interface unit 302, a path control unit 303, a CPU 304, a handset 305, and a loudspeaker 306.

The station line interface unit 302 is connected to the subscriber circuit 211 of the central telephone exchange. The path control unit 203 connects the station line interface unit 302, the handset 305, and the loudspeaker 306 to one another. The CPU 304 controls the path control unit 303.

The CPU 304 controls the path control unit 303 while the ringer signal detection unit detects the ringer signal, thereby disconnecting a conversation unit of the station line interface unit 302, the handset 305, and the loudspeaker 306 from one another.

By doing so, it is possible to prevent the ringer sound from being output from a loudspeaker of the handset 305 and from the loudspeaker 306.

What is claimed is:

1. A telephone apparatus comprising:
ringer signal detection means for detecting a ringer signal; and
disconnection means for disconnecting a loudspeaker from a line while the ringer signal detection means detects the ringer signal.

2. The telephone apparatus according to claim 1, wherein
the ringer signal detection means outputs a direct-current signal while the ringer signal has an alternating-current amplitude.

3. A telephone line connection method comprising:
a ringer signal detection step of detecting a ringer signal; and
a disconnection step of disconnecting a loudspeaker from a line while the ringer signal is detected at the ringer signal detection step.

4. The telephone line connection method according to claim 3, wherein
at the ringer signal detection step, a direct-current signal is output while the ringer signal has an alternating-current amplitude.

5. A telephone switchboard comprising:
ringer signal detection means for detecting a ringer signal; and
disconnection means for disconnecting a conversation unit of a station line interface unit from a conversation unit of an extension interface unit while the ringer signal detection means detects the ringer signal.

6. The telephone switchboard according to claim 5, wherein
the ringer signal detection means outputs a direct-current signal while the ringer signal has an alternating-current amplitude.

7. A telephone line connection method, comprising:
a ringer signal detection step of detecting a ringer signal; and
a disconnection step of disconnecting a conversation unit of a station line interface unit from a conversation unit of an extension interface unit while the ringer signal is detected at the ringer signal detection step.

8. The telephone line connection method according to claim 7, wherein
at the ringer signal detection step, a direct-current signal is output while the ringer signal has an alternating-current amplitude.
